(19) United States
(12) Patent Application Publication
(10) Pub. No.: US 2006/0031368 A1
(43) Pub. Date: Feb. 9, 2006

(54) Presence management in a push to talk system

(76) Inventor: Ian Douglas deCone, Bridgewater, NJ (US)

Correspondence Address: DARBY & DARBY P.C., P. O. BOX 5257, NEW YORK, NY, 10150-5257, US

(21) Appl. No.: 10/870,455

(22) Filed: Jun. 16, 2004

(51) Int. Cl. G06F 15/16

(52) U.S. Cl. 709/207

(57) ABSTRACT

A presence management system for a cellular-based Push-to-Talk (PTT) service. The PTT infrastructure obtains presence-relevant network status information from elements of the cellular network and of the overlying data network such as the home location registers (HLRs) of the mobile switching centers (MSCs) and the Authentication Authorization and Accounting (AAA) element of the data network. Additionally, the presence management system may communicate with other networked resources such as a Short Messaging Service (SMS) center, a Mobile Instant Messaging (MIM) server, a Multimedia Messaging Service (MMS) center, a BREW download server, or others, to obtain information about the activities of subscriber mobile phones that can be used to determine their presence. The presence management system operates in accordance with a set of configurable rules to update presence status and to provide PTT subscribers with presence status updates. Presence updates can be delivered to subscribers via Short Messaging Service (SMS) messaging or via sessions over the data network. The updates can be made in conjunction with or after a PTT call session or attempted session or can be initiated by the presence management system or a subscriber mobile phone independently of call activity.

### FIELD OF THE INVENTION

The present invention relates to systems and methods for managing information regarding the availability of members of a talk group in a push to talk (or dispatch or group calling) system, particularly a cellular telephone based push to talk or group calling system.

### BACKGROUND INFORMATION

The present invention relates to managing presence in a push to talk service on a cellular telephone network. Such a service is also commonly referred to as a group calling or dispatch communications service, but for simplicity will be referred to herein with the acronym “PTT.”

Presence relates to the ability to know with a reasonable degree of certainty whether a fellow call group member or “buddy” is available to participate in a communication session (i.e., PTT call or group call) over the network.

PTT services allow mobile phone users to engage in nearly instantaneous conversation with the simple press of a button. Generally, during a Push to Talk call, the person speaking presses a dedicated Push to Talk button on his mobile phone while talking and then releases the button when finished. Another participant in the Push to Talk call may then speak by pressing the Push to Talk button on her mobile phone.

PTT calls can be conducted between two mobile phone users or among several mobile phone users (one-to-many or point-to-multipoint communications). In a PTT call, only one party has “floor control” at any given time; i.e., only the party with floor control may speak while the other parties to the call listen.

Although similar in functionality, unlike walkie-talkies or dispatch radios, PTT service on a cellular telephone network is not limited to the radio range over which the communication device is capable. Rather than communicating directly, each of the parties engaged in a cellular call (whether it be a regular call or a PTT call) communicates with the nearest cellular base station and as such need not be located in close geographic proximity to each other. The potentially wide geographical distribution of PTT call participants adds additional complexity to the management of presence.

Various wireless carriers provide PTT services on their cellular networks. PTT service can be provided on an existing CDMA cellular network in combination with a packet-switched Internet Protocol (IP) network and other PTT-related elements, described more fully below. In such a PTT service, voice is transmitted from a mobile phone through the network to the destination mobile phone(s) in the form of packets. The communication through the network is based on packet-switched technology. In such a network, the system assigns IP addresses to PTT mobile phones such as when each PTT phone powers up and at other occasions. The IP network used may be a 1X data network.

FIG. 1 shows a block diagram of an exemplary cellular network with PTT service supported by an IP network 150. The system illustrated in FIG. 1 includes multiple mobile switching centers (MSCs) (two are illustrated) 120, each of which supports multiple base stations 110. The interconnections between the base stations 110 and the MSCs 120 are conventional. Depending on the manufacturer, some of the base stations have an associated base station controller (not illustrated). These components are used for regular cellular calls as well as PTT calls. From the MSC 120, regular cellular calls are routed through the PSTN whereas PTT calls are routed through the IP network 150. To facilitate the connection with the IP network, each MSC 120 includes (or communicates with) a packet control function (PCF) 125. Each PCF 125 communicates with one of several packet data service nodes (PDSNs) 130, each of which serves as an interface between the cellular network and the IP network 150.

An authentication, authorization and accounting (AAA) server 180 of the data network 150 is responsible for authorizing access to the data network and logging records for billing.

In order to route the calls originating in its service area to mobile phones that may be located throughout the cellular network, the MSCs 120 use databases to keep track of the location and status of all mobile phones. There are two types of databases—Home Location Registers (HLRs) and Visitor Location Registers (VLRs). Each MSC 120 is associated with an HLR. An HLR may service multiple MSCs and may be physically integrated (or co-located) with one of the MSCs or located separately. Each HLR is maintained by a cellular carrier, contains subscriber data related to features and services, and is used to identify and verify mobile phones associated with its subscribers. When a call is made to or from a mobile phone that is not identified in the HLR associated with the MSC serving the phone (i.e., a scenario known as “roaming”), the MSC queries other HLRs. Upon finding an HLR record identifying and verifying the roaming mobile phone, subscriber data is transferred from the HLR to the VLR associated with the serving MSC. The MSC then proceeds to process the call. The entry in the VLR is maintained as long as the mobile phone remains an active roamer within the MSC's area.

Multiple HLRs and VLRs, shown collectively as elements 185, are typically networked together and communicate with each other via a network 190 of SS7 links.

As shown in FIG. 1, a variety of servers may be coupled to the data network 150, including a Mobile Instant Messaging (MIM) server 202, a Short Messaging Service Center (SMSC) 204, a Multimedia Messaging Service Center (MMSC) 206, a Wireless Application Protocol (WAP) server 208, a BREW download server 210, and/or a Domain Name System (DNS) server 212.

To control the PTT service, the system of FIG. 1 includes a Control Switch (CS) 160 and an Active Directory (AD) 170, both of which communicate with other elements of the system via the data network 150. The CS 160, also referred to as the PTT server, is responsible for detecting a request to start a PTT call, determining the group of mobile phones that will participate in the PTT call, instructing the participating mobiles phones when to play the appropriate status tones, duplicating, addressing, and routing the packets, and terminating the call. There may be more than one Control Switch and more than one Active Directory and they may or may not be co-located.

The AD 170 is a database of information regarding the mobile phones enrolled in the PTT service. This database is distinct from the HLRs and VLRs used for managing regular cellular calls. The AD 170 keeps track of which PTT mobile phones are powered on and available for PTT calling. The AD 170 also maintains information on each phone's telephone number (i.e., MDN and/or MIN) and its IP address on the data network 150. The AD 170 also maintains group membership information (e.g., the fellow group members of a given subscriber).

The mobile phones that are capable of PTT service are configured with PTT software (also referred to as “client” software) and a dedicated button (the “PTT button”) that is used to initiate PTT call activity. The PTT button can also be used to perform various other functions such as reviewing the status of contacts. The PTT client software enables the specialized processing required on the mobile phone side of the PTT service. For example, the PTT client software displays user group information upon request, processes information entered by the user, dynamically displays information such as call status and participants' identities, synchronizes information with the CS and processes the voice and control data being sent to or received from other components of the PTT system.

In an exemplary system, when a PTT mobile phone powers on, the client software in the phone registers with the Control Switch 160 by sending a data packet identifying the phone. During this registration procedure, an IP address is assigned to the mobile phone. The IP address assignment is done by the PDSN 130 operating in conjunction with the AAA server 180. The PDSN 130 has a pool of available IP addresses and associates the assigned IP addresses with the MINs of the phones. The PDSN 130 also keeps track of which PCF 125 is servicing the phone. The PCF 125 in turn keeps track of which MSC 120 is servicing the phone. The mobile phone, PCF 125 and Control Switch 160 are informed of the assigned IP address. If the IP address assignment is temporary, it is released after a period of time (e.g., 24 hours) or when the phone is powered off. If the phone wanders outside the area serviced by the PDSN, the IP address is released and another address is assigned by the appropriate PDSN.

While powered on but not in use, the client PTT software in the mobile phone periodically sends a message (in a data packet) to the CS which allows the CS to keep track of which PTT phones are available to participate in PTT calls. If a mobile phones leaves the area serviced by one MSC and associated PCF and enters the area serviced by another MSC/PCF, the PDSN is updated, but the IP address may remain the same.

To initiate a PTT call, a user enters or selects one or more desired recipients or a call group and presses the dedicated PTT button. The client software in the mobile phone sends to the network the PTT call set-up information in a data packet which includes, among other things, the identification of the intended recipients or call group and a time stamp. From the mobile phone, this data packet is transmitted to a base station 110. The base station 110 receives the data packet and forwards it to the MSC 120 which forwards the packet via the PCF 125, the PDSN 130, and the IP network 150 to the Control Switch 160.

Using the Active Directory 170, the Control Switch 160 determines which mobile phones are in the call group and whether they are available to participate in the requested PTT call. The Control Switch 160 sends a set-up packet to each available destination phone to set up the PTT 20 call. Each set-up packet is addressed with the IP address of one of the destination phones. The packet includes various set-up information including some identification of the originating mobile phone. The Control Switch 160 releases the set-up packets to be routed over the IP network to the appropriate PDSNs 130 in accordance with standard IP routing. The PDSNs 130 forward the set-up packet to the PCFs 125 that are servicing the destination phones, and the PCFs forward it to the MSCs 120 servicing the destination phones. The MSCs then page the base stations to identify which ones are servicing the destination phones. Each such base station (or base station controller) assigns a forward channel for the destination phone and transmits the set-up packet to the phone. If requested by the call originator (and indicated in the set-up packet) the destination phone produces a tone indicating that a PTT call is incoming. When the destination phone receives the set-up packet from the Control Switch 160, it replies by sending a return packet with assorted information including a time stamp.

Once the Control Switch 160 authorizes and initializes the PTT call, a message is transmitted back to the originating mobile phone. The originating mobile phone generates a tone informing the user that his request for a PTT call has been granted and that he may now speak. When the user speaks (while pressing the Push to Talk button), his mobile phone will digitize his voice and wirelessly transmit it in voice packets to the base station 110, which receives the packets and forwards them to the MSC 120. The MSC, in turn, forwards the packets via the PCF 125, the PDSN 130, and the IP data network 150 to the Control Switch 160. The Control Switch 160, having previously determined the members of the talk group that will participate in the PTT call and the members' IP addresses, replicates the packets for each participating destination phone. The Control Switch 160 then updates the header of each copy of the voice packet with the current IP address of one of the destination phones. Each packet, separately addressed, is routed through the IP network 150, in accordance with standard IP routing, to the appropriate PDSN, PCF, MSC and base station, as in the case of the set-up process describe above. The base station 110, using the previously assigned forward channel, transmits the packets to the destination mobile phone where the original voice signal is reproduced for the called party to hear.

When the calling party releases the PTT button on his mobile phone, floor control is released. The Control Switch 160 sends an instruction to each participating phone to sound the appropriate tone indicating that floor control was released. Any one of the participating users may then press the PTT button on his mobile phone to gain floor control and speak to the other participants.

An exemplary approach to the management of presence in a PTT system, such as that described, uses a client-based solution. Each PTT mobile phone, in accordance with the PTT client software, sends a periodic Presence Update message (also referred to as a “heartbeat” message) to the Control Switch 160 at a predefined interval. The Presence Update message informs the Control Switch 160 that the mobile phone is still available. The response back to the mobile phone provides the updated presence status of the fellow group members (or buddies, contacts) associated with that mobile phone.

For presence to be useful to subscribers it must be accurate and timely, which requires frequent updates to the Control Switch 160. In one implementation, Presence Update messages are provided periodically at a fixed interval; e.g., every 5 minutes. During that period, one or more members of a call group can become active or inactive, rendering the presence information provided in the previous update inaccurate.

Furthermore, the aforementioned approach is inefficient for several reasons. First, there should be no reason to update the Control Switch 160 if a PTT phone's status has not changed. Such messaging is mostly redundant and unnecessary given most subscribers leave their phone on for most of the day. Second, the presence updates are accomplished using a fundamental channel, which is an expensive network resource that is essentially being used to support overhead signaling (i.e., for presence management). Third, since presence updates are performed over the fundamental channel, these sessions impact voice call delivery. For example, if presence updates take approximately 10 seconds and occur every five minutes, there are 12 intervals per hour during which an incoming voice call may be re-routed to voice mail.

Additionally, by generating and transmitting Presence Update messages at a fixed interval, without regard for the time of day, location of the mobile phone, usage patterns of the mobile phone, and/or the current work load experienced by the network, there is a sub-optimal utlitilzation of potentially scarce network resources which could compromise network performance.

As such, there is a need for more efficient, intelligent and cost effective methods and systems to manage presence in a cellular-based PTT service.

### SUMMARY OF THE INVENTION

In an exemplary embodiment, the present invention provides a method and apparatus for providing presence management in a cellular-based Push to Talk (PTT) system. The present invention provides a more efficient, intelligent and cost effective approach than that of the prior art.

In an exemplary embodiment, the PTT system is provided with relevant network status information from elements of the cellular network and of the overlying data network, namely, the home location registers (HLRs) of the mobile switching centers (MSCs) and the Authentication Authorization and Accounting (AAA) element of the data network. The HLR and AAA network elements preferably support IP or SS7 interfaces to the PTT system for the purpose of maintaining information necessary to determine presence.

Additionally, the system of the present invention is preferably capable of communicating with other systems such as a Short Messaging Service (SMS) center, a Mobile Instant Messaging (MIM) server, a Multimedia Messaging Service (MMS) center, a BREW download server, or others, to obtain information about the activities of subscriber mobile phones that can be used to determine their presence.

In a further aspect of the present invention, network status information is provided to a presence engine which operates in accordance with a set of configurable rules to update presence status and to provide PTT subscribers with presence status updates. Updates can be made during or after a PTT call session or attempted session or via SMS messaging.

Further aspects of the present invention will be best appreciated and more fully understood with reference to the following description and appended drawings.

### BRIEF DESCRIPTION OF THE DRAWINGS

FIG. 1 is a block diagram of an exemplary cellular telephone system with push-to-talk (PTT) functionality.

FIG. 2 is a block diagram of an exemplary cellular telephone system with PTT functionality comprising an exemplary embodiment of a presence management arrangement in accordance with the present invention.

### DETAILED DESCRIPTION

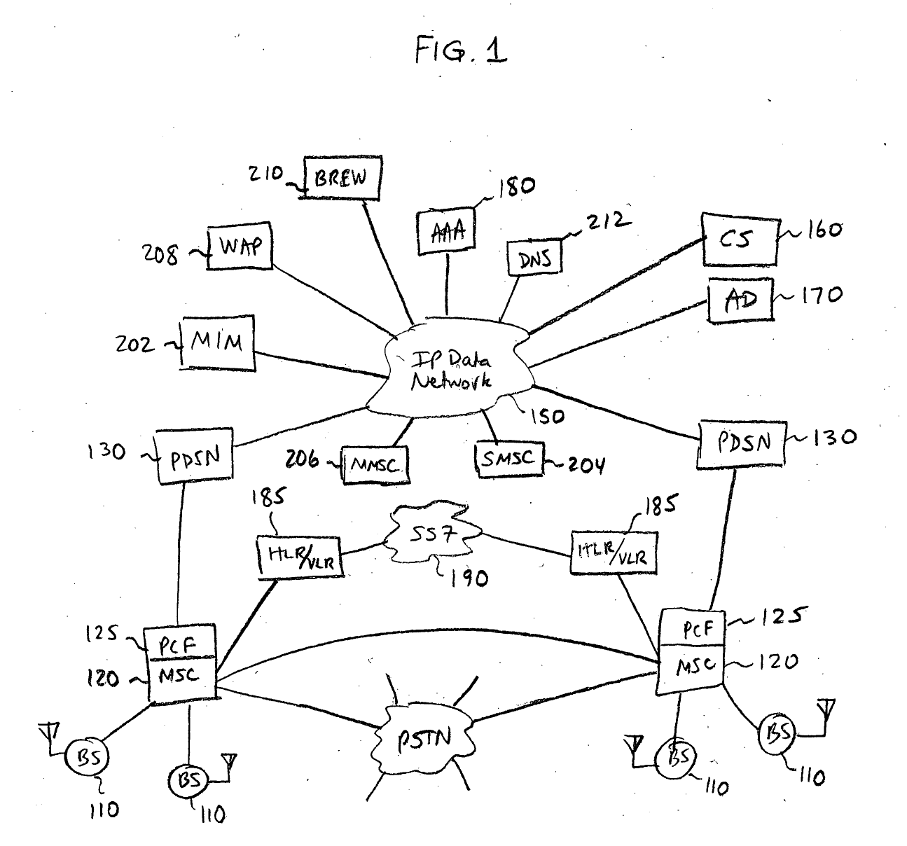

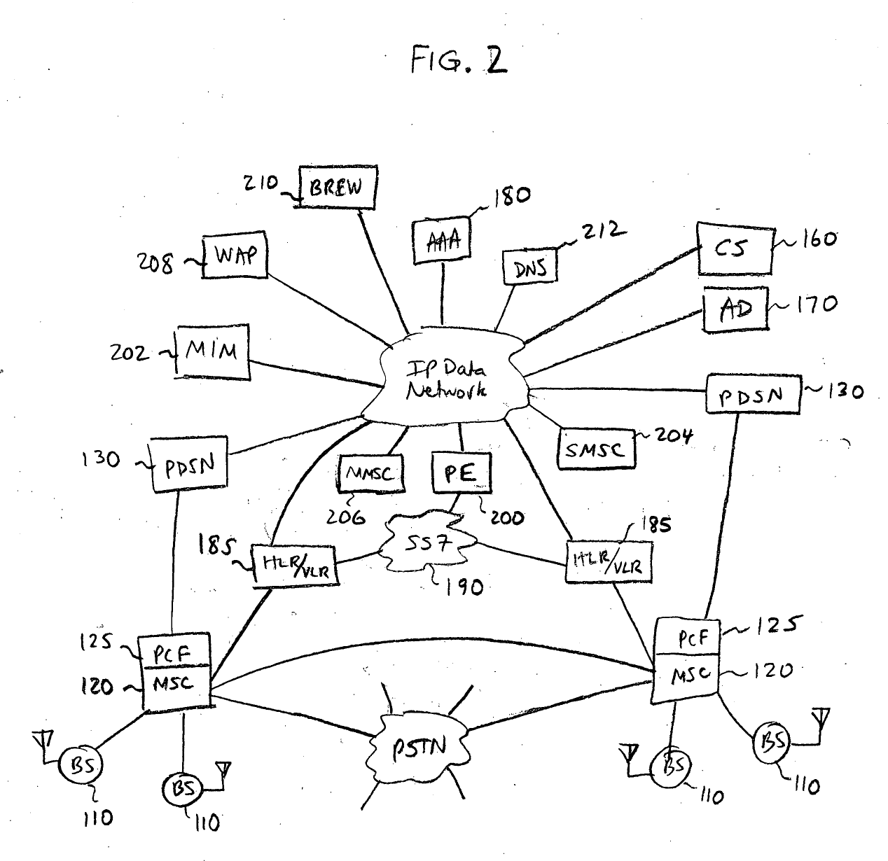

FIG. 2 shows a block diagram of an exemplary PTT system in accordance with the present invention. Elements in the system of FIG. 2 that are similar to those of the system in FIG. 1 are shown with the same reference numbers. Unless indicated otherwise, the above description for the elements in common applies.

The PTT Active Directory (AD) 170 serves as the central store for subscriber data and supports an expanded presence function or Presence Engine (PE) 200. The PE 200 is responsible for maintaining presence information for the subscribers of the PTT service. Its operation will be described in greater detail below. The Active Directory 170 serves as the central network element which disseminates presence status information to the one or more PTT Control Switch(es) 160. There may also be more than one Active Directory, but for the sake of simplicity, one Active Directory and one Control Switch are shown.

The Presence Engine 200 is coupled to the IP data network 150 via which it communicates with the other elements. The PE 200 may also be coupled to the SS7 network 190. In the system of the present invention, the HLR/VLRs 185 are preferably coupled to the IP data network 150 in addition to the SS7 network 190. The PE 200 can thus interact with the HLR/VLRs 185 via the IP data network 150 or the SS7 network 190.

The Presence Engine 200 also supports request and receipt of de-registration data from the IP network AAA server 180. The AAA server 180 is preferably capable of supporting de-registration event notification to the Presence Engine.

The Presence Engine 200 can thus poll the network of HLR/VLRs 185 and/or the AAA server 180 to determine the presence status for a given subscriber.

In addition to obtaining information that may be relevant to presence from the HLR/VLRs 185 and the IP network AAA server 180, the Presence Engine 200 can also obtain relevant information from other elements such as a Mobile Instant Messaging (MIM) server 202, a Short Messaging Service Center (SMSC) 204, a Multimedia Messaging Service Center (MMSC) 206, a Wireless Application Protocol (WAP) server 208, a BREW download server 210 and/or a Domain Name System (DNS) server 212, among others. These elements are typically coupled to the IP data network 150. As a PTT subscriber mobile phone interacts with these various applications, information can be gleaned therefrom by the Presence Engine 200 to determine the presence status of the mobile phone with varying degrees of certainty. For example, if a PTT subscriber mobile phone recently received a MMS message, the Presence Engine 200 can thus determine from the MMSC 206 that the mobile phone is active as of the time of the message. The Presence Engine 200 can thus use this information to update the presence information for that mobile phone without having to query other resources (e.g., HLR/VLRs).

With the information obtained from the aforementioned various sources, the Presence Engine 200, determines the presence status of PTT subscribers. In accordance with a configurable rule structure described more fully below, the Presence Engine 200 then determines how and when changes in presence status are to be distributed to interested parties (e.g., other subscribers).

The network of HLR/VLRs 185 associated with a cellular system maintain indicators as to whether each subscriber mobile phone homed on the system is “Active” or “Inactive” and the last known MSC 120 (as identified by a Mobile Switching Center ID or MSCID) with which the subscriber phone registered. Subscribers either manually de-register from the network by powering their phone off, or the network de-registers them if there is no autonomous registration (AR) from a subscriber within a defined interval (set by a registration timer).

Because PTT mobile phones are typically programmed to register with the PTT Control Switch 160 upon power-up, the Presence Engine 200 can ignore the initial registration of a PTT mobile phone with an HLR for purposes of determining the presence status of the mobile phone. When a PTT subscriber mobile phone changes serving MSCs, however, the HLR/VLRs 185 can provide relevant information. If data roaming on the IP data network 150 is not supported, for a roaming subscriber PTT telephone to be considered available for a PTT call, the PTT Control Switch 160 needs to determine whether a subscriber has registered on an MSC 120 that supports connectivity to the IP data network. There are several approaches to this problem.

In a first approach, the HLR/VLRs 185 provide registration updates to the Presence Engine 200 for changes in the registered MSCID of a PTT subscriber mobile phone. The PTT Control Switch 160 reviews the MSCID against a table of MSCIDs of MSCs that support connectivity to the IP data network 150 to determine whether the mobile phone is on the IP data network. If so, the mobile phone is considered available for a PTT call and the Presence Engine 200 indicates the mobile phone's presence status accordingly.

In a second approach, HLR/VLR registrations and updates are not sent to the PTT system. The Presence Engine 200 maintains a presence inactivity timer that assumes, based on the lack of PTT call activity (e.g., for one hour or more), that the mobile phone has left the PTT system. If so, the PTT system attempts to send a SMS message to the mobile phone to confirm that it is still on the IP data-enabled network. Because a SMS message could be deliverable beyond the coverage area of the PTT system, this may not be a viable approach unless the mobile phone can respond with a SMS containing the serving System ID (SID). (The SID represents a collection of geographically proximate MSCs; i.e., a SID corresponds to a group of MSCIDs.)

In a third approach, if the inactivity timer for a mobile phone expires, the Control Switch 160 polls the HLR/VLRs 185 for the phone's status as opposed to sending a SMS message to the phone. This would require the Presence Engine 200 to maintain subscriber HLR information, which would add complexity. Depending on the frequency of MSCID changes in some markets, however, this may be the most efficient approach.

In addition to HLR/VLR registrations and MSCID updates, another event that provides presence information for a PTT subscriber mobile phone is de-registration or power-down. As a PTT subscriber mobile phone powers-down, the phone is typically programmed to send a message to the PTT Control Switch 160 informing the Control Switch that it will imminently power down before actually doing so. The Presence Engine 200 can then update the presence status for that phone as being inactive or unavailable for a PTT call. There may be occasions, however, in which a PTT subscriber mobile phone will lose power abruptly (e.g., due to damage, battery loss) and will not be able to transmit such a message. In that case, the mobile phone will eventually be de-registered by its serving HLR/VLR. An HLR/VLR de-registration message to the Presence Engine 200 will thus provide conclusive information that the mobile phone is not available.

In an exemplary embodiment, different classes of presence service can be provisioned on a per-subscriber basis. For selected subscribers, their HLR/VLR registration and/or de-registration update events are automatically reported to the Presence Engine 200. To support this feature, the HLR/VLRs 185 should allow programmatically provisioning a set of subscribers for which registration and/or de-registration notifications will be generated and transmitted. For each such subscriber, the HLR/VLRs 185 will also be provided with information for the destination (e.g., IP address of the Presence Engine) of the event notifications. Such notifications should be delivered preferably via the IP data network 150 within a predetermined time period (e.g., on the order of seconds) after the event. The SS7 network 190 may also be used for such purposes. Confirmation of delivery to the Presence Engine is optional.

In an exemplary embodiment, the information provided in the de-registration message from the HLR/VLRs 185 to the Presence Engine 200 may include the subscriber mobile directory number (MDN), the mobile identification number (MIN), time of de-registration, and the GMT Offset for the HLR. If, as preferred, the Presence Engine 200 maintains a database of MSCIDs, the GMT Offset for each HLR will likely be known, in which case inclusion of the GMT Offset in the de-registration message would not be necessary.

In addition, or as an alternative to receiving presence-relevant information from the HLR/VLRs 185 as initiated by the HLR/VLRs, the Presence Engine 200 can also preferably query the HLR/VLRs 185 (via the IP data network 150 or the SS7 network 190) for the status of specific subscriber mobile phones. Such a query can specify the MDN or MIN of the mobile phone in question and the response from the HLR/VLRs 185 preferably indicates whether the phone is Active or Inactive, the last known MSCID of the MSC 120 with which the phone was registered, and the time, if available. Such queries are to be processed and results returned preferably within seconds.

As mentioned, another source of information that is relevant for presence is the AAA server 180 of the IP data network 150. Subscribers registering on the IP data network 150 authenticate with the AAA server 180 which maintains their data sessions. Data sessions on the IP network 150 may also be referred to herein as Point-to-Point Protocol (PPP) sessions. There are events which will cause a PPP session to terminate, including an unexpected failure of the session or the expiration of a PPP session timer. The PPP session timer is set by the AAA server upon initiation of a PPP session, at which point the subscriber is assigned a temporary IP address. Upon expiration of the PPP session timer, the subscriber loses the temporary IP address. In an exemplary embodiment, the PPP session timer is set to approximately 24 hours.

In an exemplary embodiment, the AAA server 180 supports a class of service which may be programmatically provisioned for a set of subscribers. As in the case of the HLR/VLRs 185, under such a class of service scheme, the AAA server 180 reports registration and/or de-registration events for programmatically provisioned subscribers to target destinations (e.g., the Presence Engine 200) specified for the subscribers.

Notifications of any such events involving a subscriber mobile phone may be sent to the Presence Engine 200 via the IP data network 150 and preferably contain the phone's MIN and/or MDN, a reason indicator for de-registration, the time of de-registration, and the GMT Offset for the AAA server 180. This ability would allow setting the PPP session timer to a period that is more appropriate to the provision of PTT service, such as one or two hours.

The AAA server 180 can be polled via the IP data network 150 by the Presence Engine 200 as to the status of a subscriber mobile phone's data session. Queried with either the phone's MDN or MIN, the AAA server 180 preferably responds with an “Active” or “Inactive” status indication. The response may also include other useful information such as the amount of time left on the mobile phone's PPP session timer.

Another source of information to the Presence Engine 200 are the one or more Control Switches 160 and Active Directories 170 in the PTT-enabled cellular network. The Control Switch 160 provides PTT usage activity to the Presence Engine 200. In addition to providing presence data upon power-up registration (Initial Registration) of a mobile phone, the Control Switch 160 also provides the Presence Engine 200 with data as to call activity (barge or alert) and call participation (i.e., participation of a subscriber in a PTT call originated by another). In an exemplary embodiment, presence updates from the Control Switch 160 indicate call success or failure (with a call failure reason code) and GMT offset time for the subscriber, if determined. In cases where the called party did not respond, there are a number of reasons, each of which may have a bearing on presence status.

Other instances in which presence can be updated include upon powering down of a mobile phone or upon losing connectivity to the data network 150. The PTT client sends a message, such as a SIP Notify or a SMS, to the Control Switch 160 indicating the occurrence of such an event. Thus, prior to allowing the mobile phone to de-register from the cellular network, the client causes the mobile phone to first de-register from the Control Switch 160. It is preferable that this messaging be controllable by the Control Switch 160 so that it can be disabled if de-registration activity can be determined by the network directly.

Presence Status Confidence and Subscriber Profiles

Having obtained presence-relevant information from various sources as described above (e.g., HLR/VLRs, AAA server, Control Switches, servers of other applications), the Presence Engine of the present invention operates in accordance with a set of hierarchical rules to determine a Confidence Index as to the presence status of a given subscriber PTT mobile phone at a point in time. The Confidence Index for a subscriber mobile phone indicates how accurate the presence status for that subscriber is based on a weighting of various inputs, discussed more fully below. Based on the Confidence Index, additional rules are then applied determine whether to deliver notification of the updated presence status of a given subscriber to the interested parties; i.e., buddies and group co-members of the subscriber. In accordance with an exemplary embodiment, notifications of changes of the presence status are carried out in accordance with rules which take into account the volume of updates over a defined interval so as to optimize the use of system resources.

The Presence Engine 200 maintains a flag indicating whether a subscriber mobile phone with a given MDN is Active or Inactive. Any one of the events listed in the following table would cause an update of this flag.

| | | Con- |
|---|---|---|
| | | fidence |
| Event | Treatment | % |
| PTT Initial Registration (On Power Up) | ACTIVE - set PIT | 100 |
| PTT Call Processed - upon end of call | ACTIVE - reset PIT | 100 |
| Phone Initiated Update on Power-down | INACTIVE | 100 |
| Control Switch - | ACTIVE - reset PIT | 100 |
| Alert to MDN Successful | | |
| Control Switch - | ACTIVE | 0-100 |
| SIP Invite Failure Reason | | |
| Code = X | | |
| Control Switch - | ACTIVE | 0-100 |
| SIP Invite Failure Reason | | |
| Code = Y | | |
| Control Switch - | INACTIVE | 100 |
| SIP Invite Failure Reason | | |
| Code = Z | | |
| Control Switch - Alert Failure - Reason | ACTIVE | 0-100 |
| Code = X | | |
| Control Switch - Alert Failure - Reason | ACTIVE | 0-100 |
| Code = Y | | |
| Control Switch - Alert Failure - Reason | INACTIVE | 100 |
| Code = Z | | |
| De-Registration Update from the AAA | INACTIVE | 100 |
| De-Registration Update from HLR | INACTIVE | 100 |
| Presence Inactivity Timer (PIT) | ACTIVE - Poll HLR, | 100 |
| Expires for an ACTIVE subscriber | if Active, & Valid | |
| | MSCID, Poll AAA if | |
| | Active - reset PIT. If | |
| | inactive with HLR Set | |
| | as INACTIVE. If | |
| | Active with HLR and | |
| | AAA is inactive - Set | |
| | as INACTIVE. | |
| PTT Call Attempt (Barge/Alert) | ACTIVE | 100 |

Events that affect presence can be classified as conclusive or non-conclusive. Conclusive events are those that provide a definitive status as to whether a subscriber is Active or Inactive and include, for example, PTT Initial Registrations, PTT call activity, HLR De-registrations and AAA De-registrations.

Non-conclusive events include PTT call activity that failed. Based on reason code indicators for call failure, these events will be weighted in the determination of the Confidence Index for a subscriber.

As indicated in the above table, in the case of SIP Invite or Alert failures, there are several reasons for such failures, some of which (Reason Code Z) provide definitive presence information and thus yield a Confidence Index of 100%. Such a reason for failure would be if the mobile phone was indeed present but unable to accept the SIP Invite or Alert because it was busy doing something else.

In the case of PTT usage activity, a Presence Inactivity Timer (PIT) is set or reset or the Confidence Index is adjusted in accordance with the above table. The PIT is preferably a programmable parameter and can be adjusted based on experience (e.g., at least 1 hour.) Provided that the HLR and AAA de-registration updates are functioning properly, there is no need to review presence status unless the subscriber has roamed to an MSC that does not support data on the data network 150, in which case a de-registration message would not be received by the HLR.

In an exemplary embodiment, other parameters that go into the determination of the Confidence Index of a subscriber as well as other relevant information are maintained in a subscriber profile. The parameters are based on the various inputs from the network elements and include Presence Aging, Home System, Last Known System, Average Number of Calls (over a certain period) and Standard Deviation, Usage Classification, Presence Privacy and Presence Population.

An exemplary Subscriber Presence Profile with illustrative parameter values is as follows:

| Subscriber | MDN/MIN |
|---|---|
| Status | ACTIVE |
| Confidence Index | 80% |
| Presence Aging | 20 |
| Home System | MSCID |
| Last Known System | SID/MSCID |
| Average Calls last 10 hours | 30 |
| Standard Deviation | 10% |
| Usage Classification | HIGH |
| Presence Privacy | Global |
| Presence Population | 25 |

The subscriber mobile telephone may be identified by MDN and/or MIN. The subscriber's profile indicates the subscriber's status (ACTIVE/INACTIVE) and Confidence Index (0-100%).

Presence Aging refers to the time interval since the subscriber's last Conclusive Event. It is used in conjunction with other data inputs to determine the Confidence Index and Presence Engine actions (e.g., query the HLR and or the AAA).

A Home System parameter is provisioned as part of service activation and is used to support HLR query activity. This parameter indicates the MSC (MSCID) on which the subscriber is “homed,” and thus the location of the subscriber's HLR.

A Last Known System parameter is either the System ID (SID) based on the latest PTT call activity or the MSCID if a subsequent query is made to the HLR. This information is useful

for managing presence update delivery based on the location and/or time zone of the subscriber receiving the update, as described in greater detail below.

Statistics on the average number of calls over an interval of time (e.g., 1 week or less) including a running average and the standard deviation of the number of calls are preferably maintained in each subscriber's profile. These statistics can be used to update a subscriber's Usage Classification (High, Moderate, Low) which could be used in the setting of the presence Confidence Index and in determining the presence update interval. The determination of whether a subscriber has High, Moderate or Low usage can be used to determine the confidence that the presence Status is accurate and the interval for which a subscriber should receive presence updates. For example, it is expected that for a subscriber with a Usage Classification of High (based on higher average calling patterns), inputs affecting the subscriber's presence status would continue with greater frequency than a user with a Usage Classification of Low. Such segmentation based on usage allows for the use of different timers for presence polling (e.g., checking an HLR or AAA).

A Presence Privacy parameter in the subscriber profile allows a subscriber to hide his presence from all users (Global Privacy) or from specific users. If the Presence Privacy parameter for a subscriber is set to Global Privacy, the system does not maintain and update presence data about this subscriber.

Another parameter in the subscriber profile, the Presence Population parameter, indicates the total number of buddies for a given subscriber. The Presence Population for a subscriber affects the number of potential presence status updates. This parameter, in addition to the subscriber's Usage Classification, can be used to determine the frequency of presence updates for the subscriber.

Other factors that can be taken into account in determining how often to update presence is the time of day and the average call activity for that time. In an exemplary embodiment, a 24-hour period can be divided into four time groups: midnight to 6 am; 6 am to 9 am; 9 am to 6 pm; and 6 pm to midnight. The average number of calls and standard deviation over the general user population can be used to predict call activity and hence presence update activity rules for presence maintenance.

Some network elements, such as HLRs, may lack the ability to send only de-registration notification events to the Presence Engine, in which case all registration events would be sent to the Presence Engine. As such, the Presence Engine may include filtering logic to only capture and update subscriber profiles with relevant data.

Presence Update and Nofification Rules

As the presence status of PTT subscribers is updated at the Presence Engine 200, the updated presence information must then be delivered to those subscribers that have an interest in or would be affected by such information, such as the buddies or calling group co-members of the subscribers whose presence has changed. A further aspect of the present invention is directed to the delivery of presence information (also referred to as presence update notification).

Core presence update rules are preferably configurable and may include the following:

| | | Exemplary |
|---|---|---|
| | | values: |
| Max Presence | If there are no updates from a subscriber | N = 1 |
| Timer | via call activity, HLR or AAA de- | |
| | registration within N hours, initiate a | |
| | HLR poll and/or AAA poll if necessary | |
| | and update status. | |
| Minimum | If x or more buddies change presence | x = 2 |
| Buddy | over a y-minute interval, deliver | y = 3 |
| Changes | presence update notification. | |
| Minimum | Presence will be updated no more often | z = 5 |
| Presence Timer | than once every z minutes. | |

The various parameters, N, x, y, z in the above table are preferably programmable and/or adaptable based on a variety of factors such as operating conditions, past experience, user expectations, etc. In an exemplary embodiment, initial values for these parameters can be selected by a system administrator.

The Presence Engine keeps track of the presence information of subscribers and delivers presence status updates based on a hierarchical set of rules which are preferably configurable. In an exemplary embodiment, the Presence Engine organizes presence status updates for delivery to a given subscriber mobile phone based on a relative priority of the subscriber's buddies as determined by recent call activity. For example, if based on recent call activity it is determined that a subscriber engages in frequent calls with a particular buddy, notifying the subscriber of that buddy's presence will be given a higher priority than would be the case for other buddies with whom the subscriber communicates less frequently. Furthermore, preferably only changes in presence status are delivered to the mobile phone in order to minimize resource utilization. In an exemplary embodiment, notification can be primarily via PTT session activity and SMS messaging as a fallback, described more fully below.

In accordance with an exemplary embodiment of the present invention, a Notification Table is maintained for each PTT subscriber. The Notification Table is used to determine when to provide the subscriber with presence updates regarding the subscriber's contacts (i.e., buddies and/or groups).

An exemplary scenario will now be described to illustrate an exemplary embodiment of the present invention. In this scenario, a subscriber, John Smith, has 10 buddies in his contact list, which is loaded along with the presence status for each buddy into his mobile phone upon power-up of the mobile phone. An illustrative state of John Smith's Notification Table is as follows.

| | John Smith | 697-737-3633 | | Minutes | |
|---|---|---|---|---|---|
| | Bud- | Current | Update | Since | |
| Ref | dies: | Status | Flag | set | Priority |
| 1 | Kelly | ACTIVE | X | 3 | 2 |
| 2 | Alan | ACTIVE | | | |
| 3 | Jen | INACTIVE | | | |
| 4 | Varsha | INACTIVE | X | 6 | 1 |
| 5 | Paco | ACTIVE | | | |
| 6 | Radon | ACTIVE | | | |
| 7 | Carmen | INACTIVE | X | 1 | 3 |
| 8 | Jetta | INACTIVE | X | 2 | 4 |
| 9 | GW | ACTIVE | | | |
| 10 | Attila | ACTIVE | | | |

As the presence status for each of John Smith's buddies is updated, a corresponding Update Flag is set in his Notification Table. Presence updates would be processed for these changes as part of the processing of the next call or alert involving John Smith; upon expiration of the Presence Interval Timer; or in accordance with other rules which take into account, for example, the number of John Smith's buddies with presence updates, how much time has elapsed since such updates, and the buddies' priority levels (as indicated in the Notification Table).

In the first case, when the subscriber is involved in call activity, his Notification Table will be checked and a presence update notification message will be sent to the subscriber with the update presence information for those contacts whose Update Flags are set. The Update Flags are then reset.

In the second case, when the Presence Interval Timer for a subscriber expires, his Notification Table will be checked and a presence update notification message will be sent to the subscriber with the update presence information for those contacts whose Update Flags are set. The Update Flags are then reset.

In the third case, a presence update notification message will be sent to the subscriber regardless of the state of the Presence Interval Timer or whether the subscriber is involved in call activity if the state of the subscriber's Notification Table meets certain criteria in accordance with a preferably configurable set of rules. For example, if the sum of priority levels for those contacts in the Notification Table whose Update Flags are set exceeds a programmable/adaptable threshold, a presence update notification message will be sent to the subscriber.

Presence Status Delivery

As described below, in exemplary embodiments of the present invention, delivery of presence status updates is carried out via messages over the IP data network 150, or via SMS messaging. Further, the system of the present invention optimizes the delivery of presence updates based on a set of programmable rules described further below.

In an exemplary embodiment, presence information delivery is carried out via data sessions over the IP data network 150. Such sessions can be triggered by or in conjunction with other activities (e.g., calls, alerts) or can be carried out on their own. The presence information can be delivered during set-up of a call or alert, during a call or alert, or at the end of a call or alert. The call or alert need not be successful for the delivery to occur.

In an exemplary embodiment, the Control Switch 160 preferably provides any presence status updates at the end of a PTT call (or alert), regardless of whether or not the call was successfully set up. The mobile phone will not release the channel until the PTT client software directs it to do so. This logic would include completed calls and situations where the END button was pressed on the mobile phone. The client reviews the status of a presence timer and determines whether or not to transmit a presence update. The presence timer is maintained by the Control Switch 160 and is indicative of the last time the presence status of a subscriber mobile phone was updated. If a programmable interval (e.g. 15 mins) has elapsed since the last presence update, the client initiates a presence update.

In yet a further exemplary embodiment, presence can be updated whenever the PTT button on a subscriber mobile phone is pressed, regardless of whether or not a call is placed. When a user presses the PTT button on his mobile phone, the mobile phone requests a data channel and displays the user's contact list (this is also referred to as “contact scrolling”). Under the presumption that a subscriber will make a call, the data channel request is made in order to reduce the call set-up latency that the user would perceive. If no call or alert is attempted within a predetermined interval, e.g. 20 seconds, an air-link dormancy timer maintained by the serving MSC 120 expires. Before the link to the mobile phone is torn down, a presence update message can be sent to the phone.

If no call is attempted within a predetermined interval (e.g., 15 seconds) from the time the data session became active, a presence update can be initiated by the mobile phone client. In this case, the mobile phone client sends a data message to the Control Switch 160 requesting updated presence information for its contacts. The Control Switch 160 consults the Presence Engine 200 and responds with a presence update messsage.

If the subscriber attempts a call or an alert subsequent to the client's initiation of a presence update and the call or alert is successful (i.e., the called party responds to the SIP Invite), the presence update should be aborted. If the call or alert fails or times out, or the subscriber exits the contact list, the presence update processing should be completed.

Because some mobile phones may not be able to engage in a data session while on a voice call, a presence update message sent to a mobile phone during a voice call may need to be re-transmitted. (This is typically not a problem with presence information delivery by SMS as most mobile phones are capable of receiving SMS messages during a voice call.)

To the extent that PTT calls or attempted calls can be kept open long enough to deliver presence updates, this is the preferred method of presence update notification. SMS messaging can serve as a secondary notification method if call activity for a given subscriber is below a particular level (i.e., less than a predetermined frequency.) Control Switch logic determines the notification method used (via call sessions or SMS) in context so as not to conflict with updates that are initiated by the mobile phone client.

In a further exemplary embodiment, delivery of presence information is carried out using Short Message Service (SMS) messaging, in addition to or in lieu of delivery via the data network 150. SMS supports 140-byte messages with 8 bit encoding and 160-byte messages with 7 bit encoding. It is preferred that Standard SMS is used, although Enhanced SMS can also be used even though it requires more network resources. Each SMS presence update message is preferably packed with both buddy and group updates rather than sending an update message for buddy updates and another update message for group updates. (A group is a collection of buddies. A buddy is not necessarily a member of a group.) Message packing should maximize the number of updates per message and reduce the overall message length. The degree of SMS message packing can be regulated in accordance with message throttling rules (described below).

The number of buddies and groups that can be included in an SMS presence update message may be limited based on other data that needs to be included in such a message for the PTT client (e.g. version control, encryption, authorization and authentication information).

The PTT client software in each PTT mobile phone distinguishes SMS presence messages from other SMS messages so that it does not directly display the presence messages to the user. Selected information in the SMS presence messages may be displayed as appropriate.

With typical, present-day network performance, approximately 80% of all SMS messages are delivered to subscribers on the first attempt. Approximately 99% of those messages delivered reach the destination mobile phone within 30 seconds. Preferably, a Short Message Peer to Peer (SMPP) interface is used to allow flexibility in managing messages. The SMPP interface supports confirmation back to the originator as to whether or not the message was delivered. Options for delivery include transaction-based delivery (i.e., indicate the number of times to attempt delivery) and “store and forward” delivery (i.e., designate a time interval during which to attempt to deliver the message). The default time interval for “store and forward” delivery is a maximum of five days.

In an exemplary PTT system in accordance with the present invention, a time interval of approximately five minutes or less should preferably be used with “store and forward” delivery. The Presence Engine would then determine, based on whether there is a call in progress, whether to attempt another SMS message, or if a PTT call is in progress to deliver the update after the call.

If a predetermined number of attempts to deliver an SMS update message to a subscriber mobile phone fail, the system will then poll the subscriber's HLR to determine its status. If, for example, the subscriber mobile phone is involved in a call, the system can wait until the call ends to attempt to deliver another presence update. Furthermore, the response from the HLR could impact the presence status of the subscriber mobile phone itself, in which case the Presence Engine would update the subscriber's profile accordingly.

The SMS notification methodology used should preferably support security measures (e.g., encryption) so as to prevent spamming, spoofing, or other undesirable activities that could negatively impact presence update function or effectiveness.

Using the SMPP interface of the SMS service, the Presence Engine can send update messages using store and forward delivery, with the messages to be delivered within a configurable period of time (e.g., 5 minutes). If confirmation is received that a SMS message was successfully received by the subscriber, the subscriber's status flag (in his Subscriber Profile, described above) is updated to ACTIVE (if not already). If an “Undelivered” response is received after the configurable period of time (e.g., 5 minutes), the Presence Engine will follow default processing. At some point, after a configurable number of failures, the Presence Engine will poll the HLR of the subscriber in an attempt to determine the subscriber's status.

The Presence Engine is provided with configurable parameters to support the setting of SMS delivery and re-try delivery intervals. The following table shows exemplary values for such intervals.

| | Interval for SMS to |
|---|---|
| | Successfully Deliver |
| SMS Delivery Logic | to Subscriber |
| Initial Message Delivery | 5 minutes |
| Interval | |
| 1^{st} Retry Delivery | 5 minutes |

To avoid potential conflicts, if a subscriber initiates a call while a SMS presence update is in progress, the call activity should not trigger another presence update at the end of the call.

Presence Update Notification Throttling

In accordance with a further aspect of the present invention, the delivery of presence update messages (by SMS or data session over the data network 150) is managed so as to make intelligent use of system resources. In an exemplary embodiment, the time of day and/or location of a subscriber is used to determine the frequency of presence notifications sent to the subscriber. A time of day variable is configured so as to limit or throttle the frequency of updates over predefined time windows of peak traffic for each time zone. A time zone is determined for each subscriber based on their Home SID or, if available, last known SID based on call activity or MSCID (as byproduct of an HLR polling event).

The following table lists exemplary Time of Day throttling periods and the corresponding frequency of presence updates. Exceptions can preferably be supported on a per MSCID or SID basis should there be known capacity issues in a given market. A Peak Updates per MSCID could be established so as to limit throttling to a given MSCID. Outside of the throttling periods updates would be delivered as generated.

| | | | Peak |
|---|---|---|---|
| | | | Updates per |
| | | | MSCID |
| Time Zone | Start | End | (per minute) |
| Eastern | 7:00 am | 10:00 am | 50 |
| Eastern | 4:00 pm | 6:00 pm | 50 |
| Eastern Day Light | 8:00 am | 9:30 am | 50 |
| Eastern Day Light | | | 50 |
| Central | 8:00 am | 9:00 am | 50 |
| Central | | | 50 |
| Mountain | 8:00 am | 9:00 am | 50 |
| Mountain | | | 50 |
| Pacific | 6:30 am | 9:30 am | 50 |
| Pacific | 4:30 pm | 8:00 pm | 50 |
| Hawaii | 9:00 am | 9:30 am | 50 |
| Hawaii | | | 50 |
| Exception Table | | | |
| MSCID/SID | | | |
| 00022-001 | 8:45 am | 10:15 am | 10 |
| 00080-005 | 7:00 am | 9:30 am | 10 |
| 00121-002 | 6:00 pm | 9:00 pm | 10 |
| 00002 | 7:30 am | 8:30 am | 10 |

Those skilled in the art will recognize that there are many variations of the invention that are within the scope of the invention, therefore, the invention is to be defined only by the limitations and the equivalents thereof which the following claims set forth.

The present invention is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

It is further to be understood that all values are to some degree approximate, and are provided for purposes of description.

What is claimed is:

1. A method of processing information as to a presence of a subscriber on a communications network having wireless elements and data communication elements, the method comprising steps of:
receiving at a presence adjunct information from an element of the communications network;
generating at the presence adjunct presence status information using the information; and
transmitting the presence status information to a further subscriber.

2. The method of claim 1, wherein the element of the communications network is a Home Location Register (HLR).

3. The method of claim 1, wherein the element of the communications network is an authentication, authorization and accounting (AAA) server.

4. The method of claim 1, wherein the information comprises at least one of a de-registration information and a registration information.

5. The method of claim 1, wherein the presence status information includes a location of the subscriber.

6. The method of claim 1, wherein generating the presence status information includes determining a confidence level regarding the presence status information.

7. The method of claim 6, wherein the confidence level is determined using a predicative behavior model based on activities of the subscriber.

8. The method of claim 7, wherein the activities of the subscriber include at least one of a registration and an interaction with an application.

9. The method of claim 1, wherein transmitting the presence status information includes transmitting a Short Messaging Service (SMS) message.

10. The method of claim 9, wherein the SMS message is encrypted.

11. The method of claim 1, wherein transmitting the presence status information is subject to throttling based on at least one of a time of day and location of the further subscriber.

12. The method of claim 9, comprising suppressing transmission of presence status information to the further subscriber during processing of a call or alert involving the further subscriber.

13. The method of claim 1, wherein the presence status information is transmitted while the further subscriber is engaged in a call or alert.

14. The method of claim 1, wherein the presence status information is transmitted at the end of a call or alert involving the further subscriber regardless of whether the call or alert failed.

15. The method of claim 1, wherein the presence status information is transmitted to the further subscriber during processing of a call or alert involving the further subscriber.

16. The method of claim 1, comprising:
determining a priority level of the presence status information based on recent call activity between the subscriber and the further subscriber,
wherein the presence status information is transmitted if the priority level exceeds a predetermined threshold.

17. The method of claim 1, wherein the presence status information is transmitted to the further subscriber after the further subscriber transmits a request for a data session.

18. The method of claim 17, wherein the further subscriber transmits a request for a data session upon accessing a contact list.

19. The method of claim 1, wherein the element of the communications network providing the information comprises the subscriber.

20. The method of claim 19, wherein the information is provided in a SMS message or via a data session message.

21. The method of claim 4, wherein the de-registration information is generated in conjunction with a handset power-down event.

22. The method of claim 1, wherein the presence status information is transmitted in a data session.
